(19) United States
(12) Patent Application Publication
(10) Pub. No.: US 2013/0076171 A1
(43) Pub. Date: Mar. 28, 2013

(54) ELECTRIC MACHINE MODULE COOLING SYSTEM AND METHOD

(71) Applicants: Attila Lepres, Mezokovesd (HU); Karoly Komlossy, Debrecen (HU)

(72) Inventors: Attila Lepres, Mezokovesd (HU); Karoly Komlossy, Debrecen (HU)

(21) Appl. No.: 13/490,257

(22) Filed: Jun. 6, 2012

Related U.S. Application Data
(63) Continuation-in-part of application No. 13/243,904, filed on Sep. 23, 2011.

(51) Int. Cl. H02K 9/00; H02K 15/02

(52) U.S. Cl. 310/59; 29/596

(57) ABSTRACT

Embodiments of the invention provide a method of assembling an electric machine module, including assembling a stator core from a plurality of laminations. The stator core can include a plurality of slots, a first axial end, and a second axial end. The stator channels can be positioned through the stator core so that they can extend from the first axial end to the second axial end. The stator channels can include a first diameter. The method can provide forming a plurality of coolant members that include a second diameter that is less than the first diameter. The coolant members can be positioned within the plurality of stator channels and a pressurized fluid can be introduced into at least some of the coolant members to expand the coolant members within the stator channels so that second diameter is substantially similar to the first diameter.

### RELATED APPLICATIONS

This application is a continuation-in-part of U.S. Non-Provisional application Ser. No. 13/243,904, which was filed on Sep. 23, 2011. The entire contents of this application is incorporated herein by reference.

### BACKGROUND

Electric machines, often contained within a machine cavity of a housing, generally include a stator and a rotor. For some electric machines, the stator can be secured to the housing using different coupling techniques to generally secure the electric machine within the housing. During operation of some electric machines, heat energy can by generated by both the stator and the rotor, as well as other components of the electric machine. For some electric machines, the increase in heat energy can, at least partially, impact electric machine operations.

### SUMMARY

Some embodiments of the invention provide a method of assembling an electric machine module. In some embodiments, the method can comprise assembling a stator core from a plurality of laminations. The stator core can include at least a plurality of slots, a first axial end, and a second axial end. In some embodiments, a plurality of stator channels can be positioned through at least a portion of the stator core so that at least some of the plurality of stator channels can extend from the first axial end to the second axial end. In some embodiments, the plurality of stator channels can comprise a first diameter. In some embodiments, a plurality of coolant members can be formed so that at least some of the coolant members can comprise a curved region and a second diameter that is less than the first diameter. In some embodiments, the plurality of coolant members can be at least partially positioned within the plurality of stator channels. In some embodiments, a pressurized fluid can be introduced into at least some of the coolant members to expand the coolant members within the stator channels so that second diameter can be substantially similar to the first diameter.

### DESCRIPTION OF THE DRAWINGS

FIG. 1 is a perspective view of an electric machine module according to one embodiment of the invention.

FIG. 2 is a cross-sectional view of a portion of the electric machine module of FIG. 1.

FIG. 3 is a perspective view of a stator assembly according to one embodiment of the invention.

FIG. 4 is front view of a stator lamination according to one embodiment of the invention.

FIG. 5A is a cross-sectional view of a portion of a stator assembly and a coolant member according to one embodiment of the invention.

FIG. 5B is an expanded view of the circled portion of the coolant member of FIG. 5A.

FIG. 6 is a perspective view of a conductor according to one embodiment of the invention.

FIG. 7A is a perspective view a stator assembly according to one embodiment of the invention.

FIG. 7B is a cross-sectional view of the stator assembly of FIG. 7A.

FIG. 8A is a partial cross-sectional view of a stator assembly according to one embodiment of the invention.

FIG. 8B is a perspective view of the stator assembly of FIG. 8A.

FIG. 9 is a perspective view of a first end cap according to one embodiment of the invention.

FIG. 10 is a perspective view of a second end cap according to one embodiment of the invention.

FIG. 11 is an exploded view of a module coolant path according to one embodiment of the invention.

FIG. 12A is a partial cross-sectional view of a stator assembly according to one embodiment of the invention.

FIG. 12B is an isometric view of the stator assembly of FIG. 12.

FIG. 13 is a partial cross-sectional view of a stator assembly according to one embodiment of the invention.

FIG. 14 is a partial cross-sectional view of a stator assembly according to one embodiment of the invention.

FIG. 15A is a perspective view of an end cap according to one embodiment of the invention.

FIG. 15B is a partial cross-sectional view of the end cap of FIG. 15A.

FIG. 16 is a partial cross-sectional view of portions of an electric machine module according to one embodiment of the invention.

FIG. 17 is a partial perspective view of portions of an electric machine module representing a fluid flow according to one embodiment of the invention.

FIG. 18 is a partial cross-sectional view of a stator assembly according to some embodiments of the invention.

FIG. 19 is a partial cross-sectional view of a stator assembly according to some embodiments of the invention.

FIG. 20A is a partial isometric view of a stator assembly according to one embodiment of the invention.

FIG. 20B is an expanded view of a portion of the stator assembly of FIG. 20A.

FIG. 20C is an expanded cross-sectional view of a portion of the stator assembly of FIG. 20A.

FIG. 20D is partial cross-sectional view of a portion of a stator assembly according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

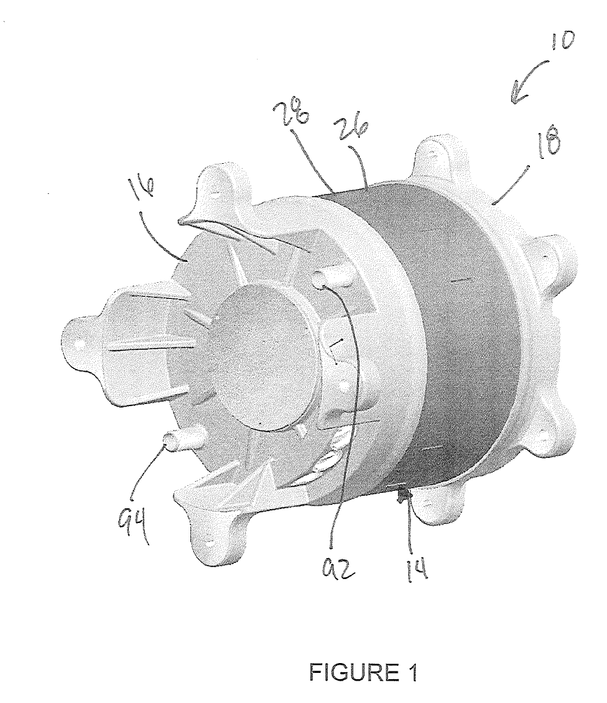

FIG. 1 illustrates an electric machine module 10 according to one embodiment of the invention. The electric machine module 10 can include a housing 12 that can substantially surround at least a portion of an electric machine 14. In some embodiments, the housing 12 can comprise a first end cap 16 and a second end cap 18 coupled to a portion of the electric machine 14. In some embodiments, the end caps 16, 18 can comprise a substantially similar configuration. In some embodiments, the end caps 16, 18 can comprise substantially different configurations relative to each other, as described in further detail below. For example, in some embodiments, the electric machine 14 can comprise a first axial end 20 and a second axial end 22 and the end caps 16, 18 can be coupled to portions of the electric machine 14 substantially adjacent to the axial ends 20, 22, as described in further detail below. Further, in some embodiments, at least some portions of the housing 12 can comprise materials that can generally include thermally conductive properties, such as, but not limited to aluminum or other metals and materials capable of generally withstanding operating temperatures of the electric machine 14. In some embodiments, the housing 12 can be fabricated using different methods including casting, molding, extruding, and other similar manufacturing methods.

The electric machine 14 can be, without limitation, an electric motor, such as a hybrid electric motor, an electric generator, or a vehicle alternator. In one embodiment, the electric machine 14 can be a High Voltage Hairpin (HVH) electric motor or an interior permanent magnet electric motor for hybrid vehicle applications.

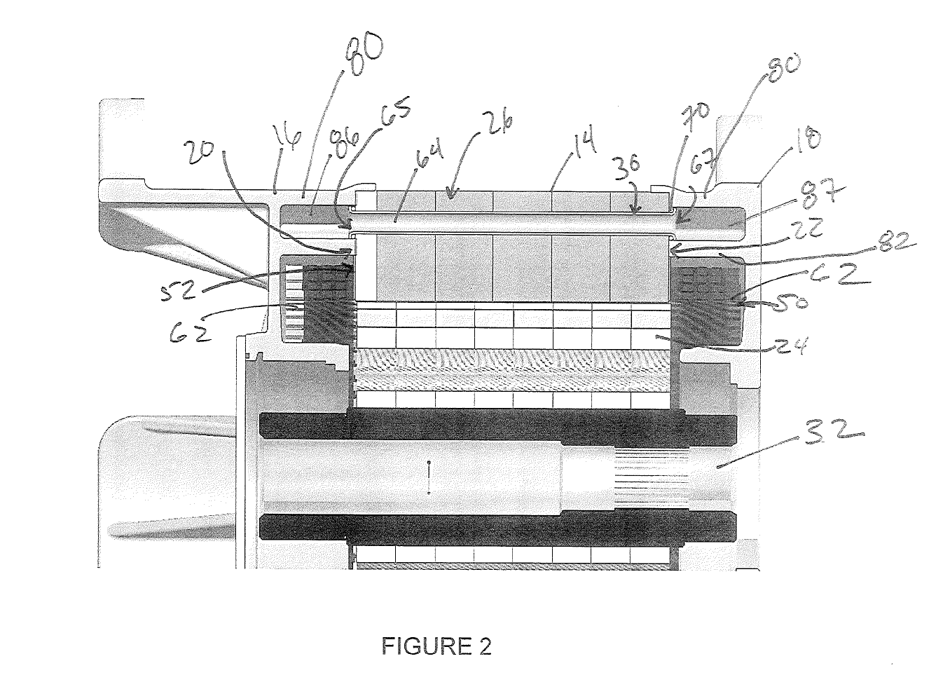

The electric machine 14 can include a rotor assembly 24, a stator assembly 26, and can be disposed about a shaft 32. As shown in FIG. 2, the stator assembly 26 can substantially circumscribe the rotor assembly 24. In some embodiments, the rotor assembly 24 can also include a rotor hub or can have a “hub-less” design, as shown in FIG. 2.

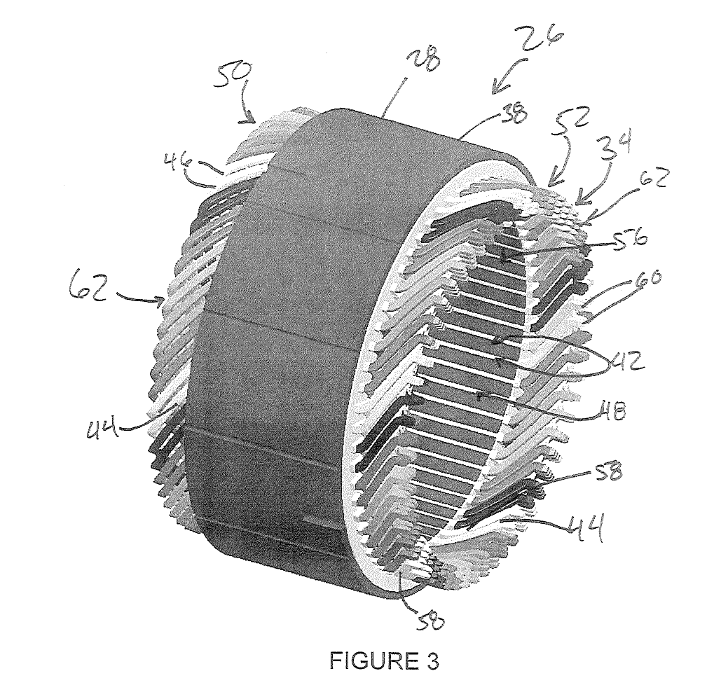

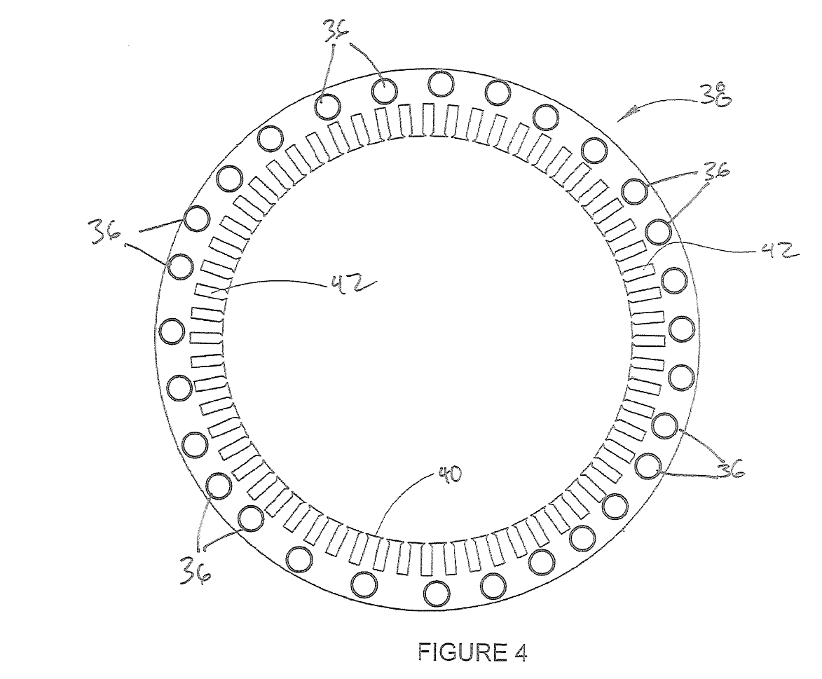

As shown in FIG. 3, in some embodiments, the stator assembly 26 can comprise a stator core 28 and a stator winding 34 at least partially disposed within a portion of the stator core 28. For example, in some embodiments, the stator core 28 can comprise a plurality of laminations 38. Referring to FIG. 4, in some embodiments, the laminations 38 can comprise a plurality of substantially radially-oriented teeth 40. In some embodiments, as shown in FIG. 3, when at least a portion of the plurality of laminations 38 are substantially assembled, the teeth 40 can substantially align to define a plurality of slots 42 that are configured and arranged to support at least a portion of the stator winding 34. As shown in FIG. 4, in some embodiments, the laminations 38 can include sixty teeth 40, and, as a result, the stator core 28 can include sixty slots 42. In other embodiments, the laminations 38 can include more or fewer teeth 40, and, accordingly, the stator core 28 can include more or fewer slots 42.

Moreover, in some embodiments, at least a portion of the laminations 38 can comprise at least one aperture 36. In some embodiments, the at least one aperture 36 can be formed at the time of manufacture of the laminations 38, and in other embodiments, the aperture 36 can be formed (e.g., stamped, machined, etc.) through at least a portion of the laminations 38 after manufacture. In some embodiments, at least a portion of the laminations 38 can comprise a plurality of apertures 36. For example, in some embodiments, as shown in FIG. 4, at least some of the laminations 38 can comprise apertures 36 at least partially circumferentially arranged and disposed through the laminations 38. In some embodiments, the apertures 36 can be circumferentially disposed in regular or irregular patterns around at least some portions of some of the laminations 38. For example, in some embodiments, the apertures 36 can be disposed through portions of some of the laminations 38 in groups of four apertures 36, although, in other embodiments, the apertures 36 can be arranged in any other groupings, including a lack of any pattern, as desired by the manufacturer or user. In some embodiments, at least some of the apertures 36 can be disposed through areas of the laminations 38 that are radially outward relative the at least a portion of the teeth 40 and/or the slots 42.

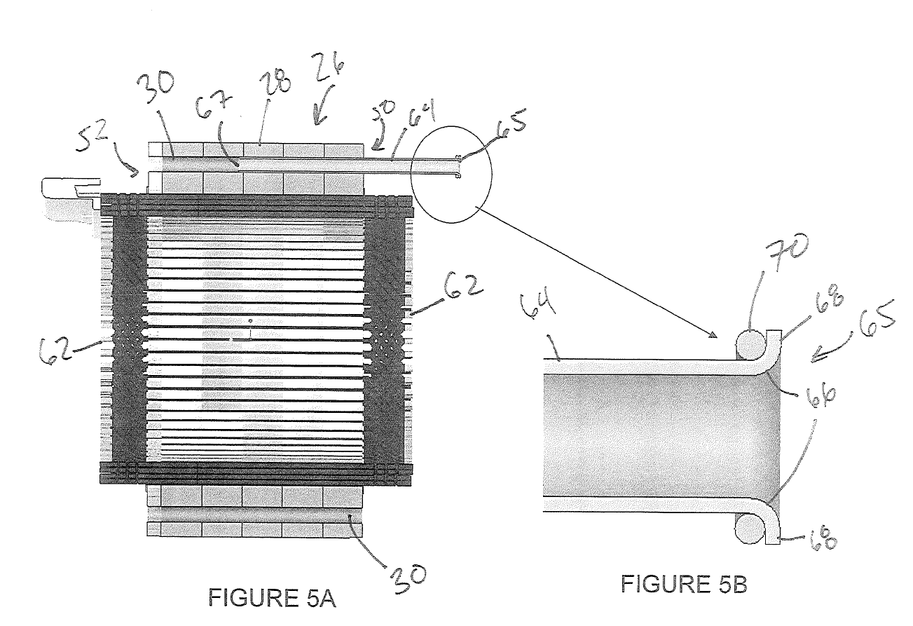

In some embodiments, at least a portion of the apertures 36 can substantially align to define stator channels 30. For example, in some embodiments, at least a portion of the laminations 38 can comprise substantially similar patterns of apertures 36 so that after assembling the stator core 28, at least a portion of the apertures 36 can substantially align to define the stator channels 30. In some embodiments, the stator core 28 can comprise substantially the same number of stator channels 30 as the number of apertures 36 disposed through the laminations 38. Furthermore, in some embodiments, at least a portion of some of the laminations 38 can comprise fewer numbers of apertures 36 relative to the desired number of stator channels 30. As a result, in some embodiments, some or all of the stator channels 30 can be disposed through some portions of the stator core 28 after assembly of the laminations 38 to form the core 28 (e.g., via machining, stamping, punching, etc.). Accordingly, in some embodiments, at least a portion of the stator channels 30 can be disposed through the stator core 28 before and/or after assembly of the stator core 28. Moreover, in some embodiments, the stator channels 30 can be disposed through the stator core 28 so that at least some of the stator channels 30 are substantially parallel to at least a portion of the slots 42, as shown in FIG. 5A.

Moreover, in some embodiments, at least a portion of the stator channels 30 can comprise an at least partially irregular inner surface. In some embodiments, the stator channels 30 can comprise a textured inner surface. By way of example only, in some embodiments, the stator channels 30 can comprise burrs arising from the process of stator channel 30 manufacture (e.g., machining, stamping, punching, etc.) so that the inner surface of at least a portion of the channels 30 is substantially or completely unsmooth. As a result, in some embodiments, the inner surface can comprise a structure that can at least partially enhance thermal energy transfer. Moreover, in some embodiments, the texture can at least partially provide for increased retention because of the textured and/or substantially unsmooth surface.

Furthermore, in some embodiments, at least a portion of the stator channels 30 can extend at least a portion of an axial length of the stator core 28. For example, in some embodiments, at least a portion of the stator channels 30 can extend from the first axial end 20 to the second axial end 22 of the electric machine 14. In some embodiments, at least a portion of the stator channels 30 can comprise a lesser axial length relative to the axial length of the stator core 28.

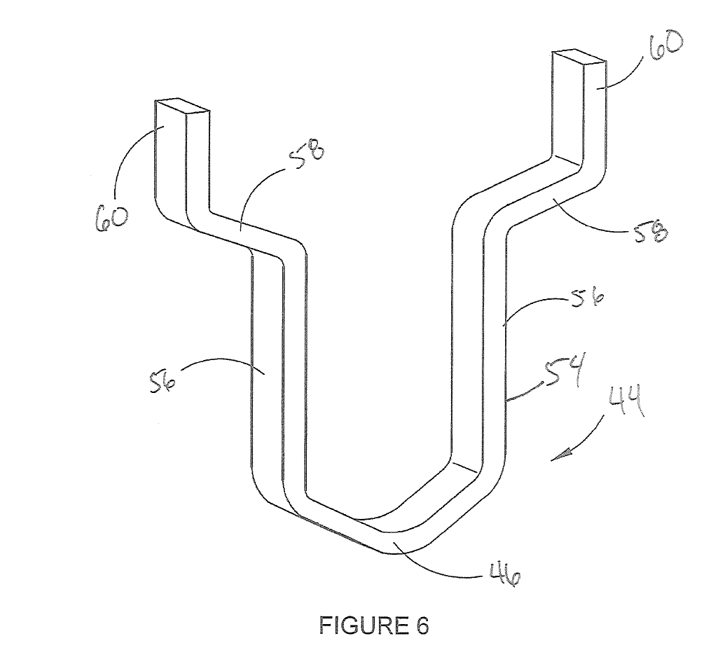

In some embodiments, the stator winding 34 can comprise a plurality of conductors 44. In some embodiments, the conductors 44 can comprise a substantially segmented configuration (e.g., a hairpin configuration), as shown in FIG. 6. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wavy shape, a curved shape, and other shapes. Additionally, in some embodiments, as shown in FIG. 6, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc.

In some embodiments, as shown in FIG. 3, at least a portion of the conductors 44 can be positioned substantially within the slots 42. For example, in some embodiments, the stator core 28 can be configured so that the plurality of slots 42 are substantially axially arranged. In some embodiments, the leg portions 48 can be inserted into the slots 42 so that at least some of the leg portions 48 can axially extend through the stator core 28. In some embodiments, the leg portions 48 can be inserted into neighboring slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 28 so that at least some of the turn portions 46 of the conductors 44 axially extend from the stator core 28 at an insertion end 50 of the stator core 28 and at least some of the leg portions 48 axially extend from the stator core 28 at a weld end 52 of the stator core 28. Furthermore, in some embodiments, the insertion end 50 of the stator core 28 can be substantially adjacent to the first axial side 20 of the electric machine 14 and the weld end 52 of the stator core 28 can be substantially adjacent to the second axial side 22 of the electric machine 14. In other embodiments, the insertion end 50 of the stator core 28 can be substantially adjacent to the second axial side 22 of the electric machine 14 and the weld end 52 of the stator core 28 can be substantially adjacent to the first axial side 20 of the electric machine 14.

In some embodiments, the conductors 44 are generally fabricated from a substantially linear conductor 44 that can be configured and arranged to a shape substantially similar to the conductor in FIG. 6. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44.

In some embodiments, before, during, and/or after shaping of the conductors 44, an insulation 54 can be applied to at least a portion the conductors 44. For example, in some embodiments, the insulation 54 can comprise a resinous material such as an epoxy or an enamel that can be reversibly or irreversibly coupled to at least a portion of the conductors 44. In some embodiments, because an electrical current circulates through the conductors 44 during operation of the electric machine 20, the insulation 54 can function, at least in part, to substantially prevent short circuits and/or grounding events between neighboring conductors 44 and/or conductors 44 and the stator core 28.

In some embodiments, at least some of the leg portions 48 can comprise multiple regions. In some embodiments, the leg portions 48 can comprise in-slot portions 56, angled portions 58, and connection portions 60. In some embodiments, as previously mentioned, the leg portions 48 can be disposed in the slots 42 and can axially extend from the insertion end 50 to the weld end 52. In some embodiments, after insertion, at least a portion of the leg portions 48 positioned within the slots 42 can comprise the in-slot portions 56.

In some embodiments, at least some of the regions of the leg portions 48 extending from stator core 28 at the weld end 52 can comprise the angled portions 58 and the connection portions 60. In some embodiments, after inserting the conductors 44 into the stator core 28, the leg portions 48 extending from the stator core 28 at the weld end 52 can undergo a twisting process (not shown) which can lead to the creation of the angled portions 58 and the connection portions 60. For example, in some embodiments, the twisting process can give rise to the angled portions 58 at a more axially inward position and the connection portions 60 at a more axially outward position, as shown in FIG. 3. In some embodiments, after the twisting process, the connection portions 60 of at least a portion of the conductors 44 can be immediately adjacent to connection portions 60 of other conductors 44. As a result, the connection portions 60 can be coupled together to form one or more stator windings 34. In some embodiments, the connection portions 60 can be coupled via welding, brazing, soldering, melting, adhesives, or other coupling methods. Additionally, in some embodiments, at least a portion of the insulation 54 can be substantially removed at the connection portions 60 in order to enable the coupling process. Although, in some embodiments, the insulation 54 can be applied to the conductors 44 so that it does not coat and/or cover the connection portions 60. Furthermore, in some embodiments, at least a portion of the conductors 44 that axially extends from the weld end 52 and the insertion end 50 of the stator assembly 26 can comprise stator end turns 62.

Components of the electric machine 14 such as, but not limited to, the rotor assembly 24, the stator assembly 26, and the stator winding 34, including the stator end turns 62, can generate heat during operation of the electric machine 14. These components can be cooled to increase the performance and the lifespan of the electric machine 14.

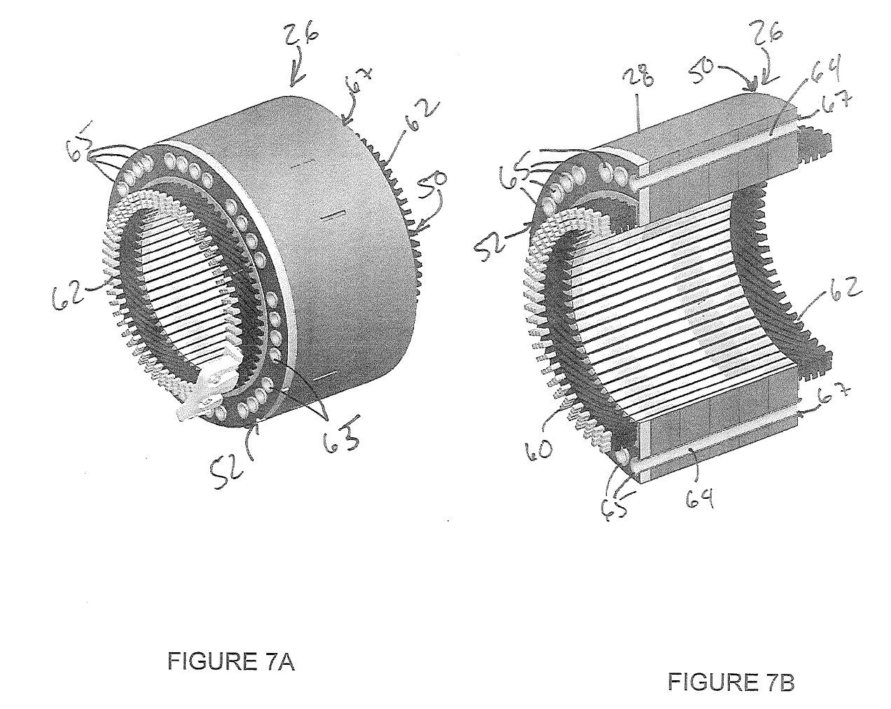

In some embodiments, the stator assembly 26 can comprise at least one coolant member 64. For example, as shown in FIGS. 5A, 7A and 7B in some embodiments, each of the stator channels 30 can comprise at least one coolant member 64. In some embodiments, at least a portion of the coolant members 64 can comprise an axial length substantially similar to the axial length of the stator core 28. In some embodiments, at least a portion of the coolant members 64 can comprise an axial length greater than the axial length of the stator core 28 so that at least a portion of the axially-outermost portions of at least some of the coolant members 64 (e.g., portions of the coolant members 64 that axially extend from the weld end 52 and the insertion end 50 of the stator core 28) can be configured and arranged as described below.

In some embodiments, at least a portion of the stator channels 30 can be configured and arranged to receive at least a portion of the coolant members 64. For example, in some embodiments, at least a portion of the coolant members 64 can comprise an outer diameter substantially similar to a circumference of at least a portion of the stator channels 30. As a result, in some embodiments, the outer diameter of at least a portion of the coolant member 64 can substantially contact portions of the stator core 28 that define the stator channels 30. For example, in some embodiments, the coolant members 64 can be in thermal communication with the stator core 28. Moreover, in some embodiments, at least a portion of the coolant members 64 can comprise a thermally-conductive material, such as aluminum, copper, a polymer, a polycarbonate, or other materials. Moreover, as discussed in further detail below, in some embodiments, at least some of the coolant members 64 can comprise an extruded polymer. In some embodiments, the coolant member 64 can be substantially hollow so that a fluid can flow through the member 64, as shown in FIGS. 2, 5A, 5B, and 7B. In some embodiments, at least a portion of an inner diameter of the coolant members 64 can comprise a structure (e.g., a ridge, a recess, a boss, etc.) (not shown) that can at least partially increase an exposed inner diameter surface area of the coolant member 64.

As shown in FIG. 5B, in some embodiments, prior to positioning at least a portion of the coolant members 64 within the stator channels 30, a first end 65 of at least some of the coolant members 64 can be configured and arranged to retain the coolant member 64 in position after disposing the coolant members 64 within the stator assembly 26. In some embodiments, the first end 65 of at least some of the coolant members 64 can be configured and arranged so that coolant member 64 comprises an angled region 66 and a retaining region 68. For example, as shown in FIG. 5B, the retaining region 68 can be oriented substantially perpendicular to a horizontal axis of the stator core 28. In some embodiments, the angled region 66 and the retaining region 68 can be formed at the time of coolant member 64 manufacture (e.g., the angled region 66 and the retaining region 68 can be formed at substantially the same time as the coolant member 64). In some embodiments, the angled region 66 and the retaining region 68 can be formed after coolant member 64 manufacture. For example, in some embodiments, the coolant members 64 can comprise a substantially malleable material (e.g., copper and/or an extruded polymer) that can be reconfigured via application of a force (e.g., bending, pushing, pulling, expanding via application of a fluid, otherwise actuated, etc.) to the first end 65 of the coolant member 64 until the first end 65 comprises the angled region 66 and the retaining region 68.

In some embodiments, at least one o-ring 70 can be positioned substantially adjacent to the angled region 66 and the retaining region 68 on at least a portion of the coolant members 64. For example, as shown in FIG. 5B, in some embodiments, the o-ring 70 can be positioned immediately adjacent to the angled region 66 (e.g., immediately radially outward) and can be at least partially held in position by the retaining region 68. In some embodiments, another structure capable of sealing the stator channels 30 can be used in addition to or in lieu of the o-ring 70 (not shown).

As previously mentioned, in some embodiments, the coolant members 64 can be positioned in the stator channels 30. For example, as shown in FIG. 5A, in some embodiments, a second end 67 of the coolant members 64, which can substantially oppose the first end 65, can be inserted through the stator channels 30 until the o-ring 70 of the first end 65 at least partially contacts an axial face of the stator core 28. Moreover, in some embodiments, the second end 67 can at least partially axially extend from the stator core 28 (e.g., the coolant member 64 comprises a greater axial length than the stator core 28).

In some embodiments, to at least partially seal the stator channels 30 and to retain at least a portion of the coolant members 64 in place, at least a portion of the second ends 67 of the coolant members 64 can be configured and arranged substantially similar to at least some of the first ends 65. In some embodiments, an o-ring 70 can be positioned over the outer diameter of the coolant member 64 and disposed substantially adjacent to the stator core 28. By way of example only, in some embodiments, a forming tool 72 can then contact the coolant members 64 to substantially reconfigure the second ends 67.

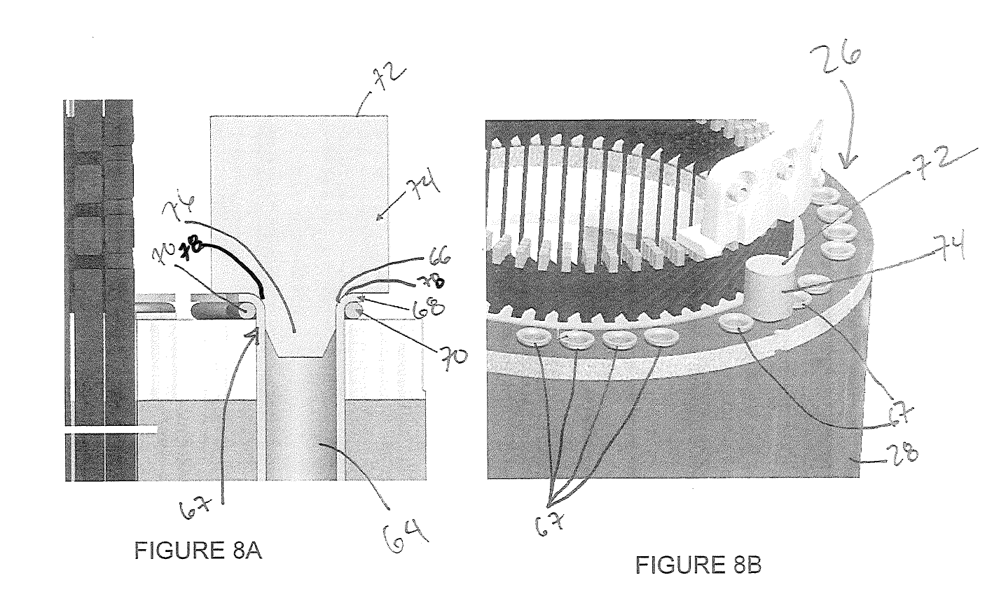

As shown in FIGS. 8A and 8B, in some embodiments, the forming tool 72 can be configured and arranged to at least partially displace portions of the second end 67 of the coolant member 64 (e.g., to form the angled region 66 and the retaining region 68). For example, in some embodiments, the forming tool 72 can comprise a body 74, an extension 76, and a curved region 78. In some embodiments, the extension 76 can be dimensioned to be received within portions of the coolant member 64 (e.g., the extension 76 can comprise an outer diameter that is equal to or less than the inner diameter of the coolant member 64). As a result, in some embodiments, the forming tool 72 can be positioned so that the extension 76 is at least partially disposed within the coolant member 64, the curved region 78 is immediately adjacent to the axially-outermost portion of the second end 67, and the body 74 is axially outward relative to the second end 67. In some embodiments, an axially inward-directed force can be applied to the forming tool 72 to form the angled region 66 and the retaining region 68 at the second end 67 (e.g., the second end 67 is reformed to comprise a substantially similar configuration relative to the first end 65). For example, in some embodiments, the o-ring 70 can be positioned between the retaining region 68 and the stator core 28 so that the stator channels 30 can be substantially sealed by the o-ring 70, similar to the first end 65. Moreover, in some embodiments, the forming tool 72 can be used in forming the first end 65 prior to disposing the coolant member 64 within the stator channel 30. As a result of the angled regions 66, retaining regions 68, and the o-rings 70 on the first end 65 and the second end 67 of at least a portion of the coolant members 64, in some embodiments, an interface between the stator core 28 and the ends 65, 67 can be substantially sealed so that no material amounts of fluid can enter the stator channels 30 and both ends 65, 67 of the coolant member 64 can be substantially retained in position, as shown in FIGS. 7A-8B.

In some embodiments, the forming tool 72 can be used in different manners to configure and arrange portions of at least some of the coolant members 64. For example, as shown in FIGS. 8A and 8B, one forming tool 72 can be used to configured each coolant member 64 (e.g., each second end 67 can be individually configured and arranged to substantially seal each stator channel 30). In some embodiments, a plurality of forming tools 72 can be used to configure and arrange more than one coolant member 64 at a time. For example, a device (not shown) comprising a plurality of forming tools 72 can be coupled to the stator assembly 26 so that some or all of the coolant members 64 can be configured at about the same time. In other embodiments, the device can comprise a number of forming tools 72 less than the number of coolant members 64 so that a group of coolant members 64 can be configured and then the device can circumferentially move to configure another group of coolant members 64. Furthermore, in some embodiments, the stator assembly 26 can be positioned so that devices with forming tools 72 can configure both ends 65, 67 of the coolant member 64, at substantially the same time. Accordingly, in some embodiments, after forming the ends 65, 67, the stator assembly 26 can comprise at least one coolant member 64 substantially axially oriented through a portion of the stator core 28 and the stator channels 30 can be substantially sealed so that a fluid can pass through at least a portion of the coolant members 64.

In some embodiments, the electric machine 14 can be coupled the housing 12. For example, in some embodiments, at least a portion of the electric machine 14, such as the stator assembly 26, can be operatively coupled to the end caps 16, 18. In some embodiments, the end caps 16, 18 can be coupled to the stator assembly 26 via conventional fasteners (not shown) or other coupling techniques to secure the end caps 16, 18 to the ends 50, 52 of the stator assembly 26, as shown in FIGS. 1 and 2.

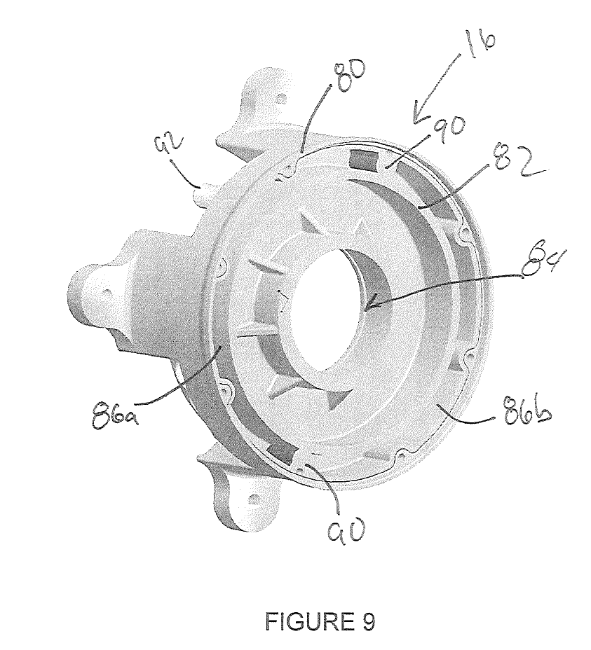

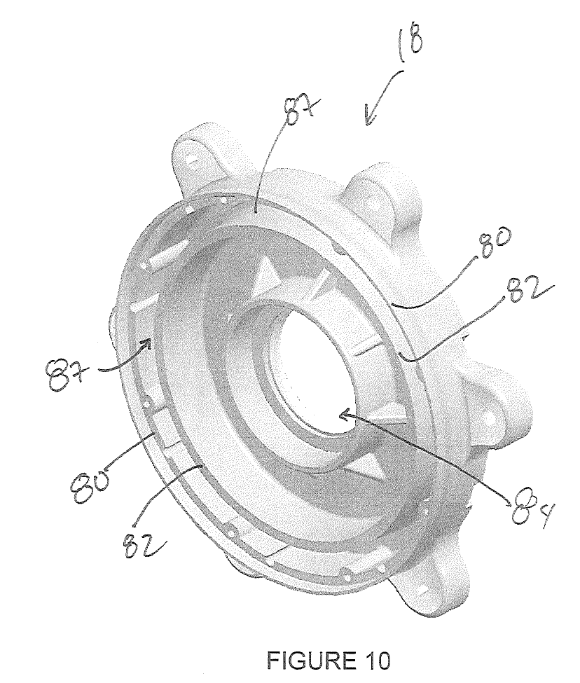

In some embodiments, the end caps 16, 18 can comprise an outer flange 80 and an inner flange 82, as shown in FIGS. 9 and 10. In some embodiments, the outer flange 80 can be positioned substantially radially outward relative to the inner flange 82. In some embodiments, the flanges 80, 82 can be coupled to the end caps 16, 18 after manufacture. In other embodiments, the end caps 16, 18 can be formed (e.g., cast, machined, extruded, etc.) so that the flanges 80, 82 are substantially integral with at least one of the end caps 16, 18. Moreover, in some embodiments, the outer flange 80 can also function as a radially outer wall of the end caps 16, 18. Additionally, in some embodiments, at least one of the end caps 16, 18 can comprise a central aperture 84 that is configured and arranged to receive at least a portion of the shaft 32 so that the shaft 32 can extend through the end caps 16, 18 and operatively couple to other structures.

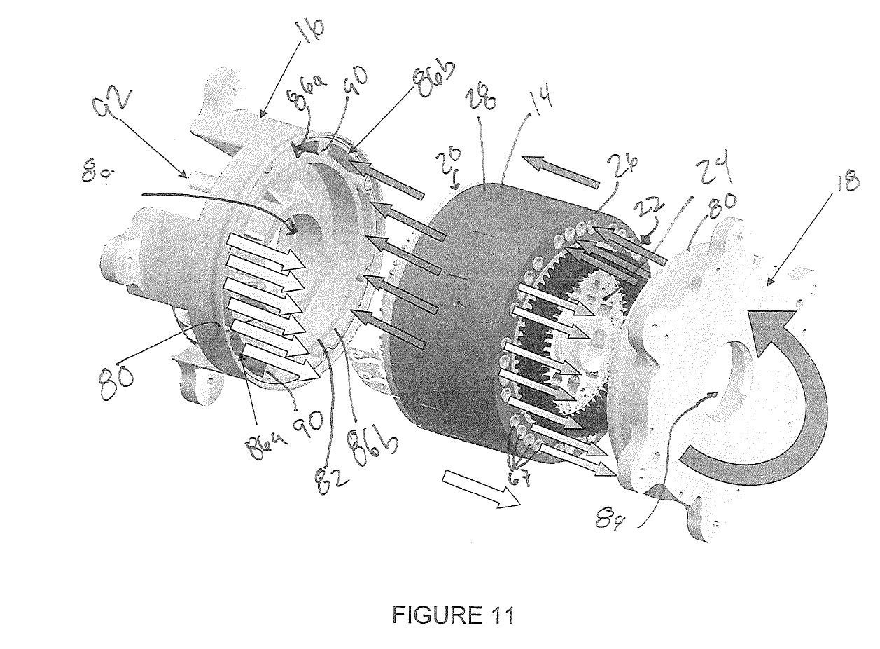

In some embodiments, the end caps 16, 18 can comprise at least two manifolds 86, 87. For example, in some embodiments, the first end cap 16 can comprise a manifold 86 and the second end cap 18 can comprise a manifold 87. In some embodiments, the flanges 80, 82 can define at least a portion of the manifolds 86, 87. As shown in FIGS. 9 and 10, in some embodiments, the manifolds 86, 87 can be disposed substantially between the flanges 80, 82 of the end caps 16, 18 and at least partially further axially defined by an inner wall 88 of the end caps 16, 18. Moreover, in some embodiments, after coupling the end caps 16, 18 to the stator assembly 26, the manifolds 86, 87 can be in fluid communication with at least a portion of the coolant members 64. For example, as shown in FIGS. 2 and 11, in some embodiments, the flanges 80, 82 can be configured and arranged so that the manifolds 86, 87 of each of the end caps 16, 18 can fluidly connect to each other via at least a portion of the coolant members 64. Moreover, in some embodiments, a sealing structure (not shown) (e.g., an o-ring) can be disposed between an axially inward portion of the flanges 80, 82 of the end caps 16, 18 and the stator assembly 26 to substantially seal the manifolds 86, 87 so that at least a substantial portion of any fluid that enters the manifolds 86, 87 can substantially only flow through the coolant members 64.

In some embodiments, the end caps 16, 18 can comprise multiple configurations. In some embodiments, the first end cap 16 can comprise at least two manifolds 86a, 86b (e.g., a first manifold 86a and a second manifold 86b). In some embodiments, as shown in FIGS. 9 and 11, the first end cap 16 can comprise at least two ribs 90 that are configured and arranged to substantially divide the manifold 86 (e.g., radially oriented between portions of the flanges 80, 82) into the first and the second manifolds 86a, 86b. Moreover, in some embodiments, the ribs 90 can be positioned so that each of the manifolds 86a, 86b comprise a substantially equal size (e.g., the ribs 90 are positioned at substantially opposite points on the first end cap 16). In some embodiments, the ribs 90 can be positioned in any other orientation to define manifolds 86a, 86b in any desired proportion. For example, in some embodiments, the ribs 90 can be positioned substantially adjacent to each other so that one of the manifolds 86a, 86b is substantially smaller than the other. In some embodiments, the first end cap 16 can comprise more than two ribs 90 so that the first end cap 16 can comprise a plurality of manifolds 86 (not shown). In some embodiments, second end cap 18 can comprise ribs 90, although, in other embodiments, the second end cap 18 can lack ribs 90 so that the second end cap 16 comprises a substantially continuous circumferentially arranged manifold 87, as shown in FIG. 10. Additionally, in some embodiments, the ribs 90 can be coupled to and/or substantially integral with at least a portion of the end caps 16, 18.

In some embodiments, the first end cap 16 can comprise at least one inlet 92 and at least one outlet 94. As shown in FIGS. 1, 9, and 11, in some embodiments, the first end cap 16 can comprise the inlet 92 operatively coupled to a portion of the end cap 16 so that the inlet 92 is in fluid communication with at least one of the manifolds 86a, 86b. In some embodiments, the inlet 92 can be coupled to the end cap 16 after manufacture, and in other embodiments, the inlet 92 can be substantially integral with the end cap 16. As shown in FIG. 1, in some embodiments, the first end cap 16 can comprise the outlet 94 operatively coupled to a portion of the end cap 16 so that the outlet 94 is in fluid communication with at least one of the manifolds 86a, 86b. In some embodiments, the outlet 94 can be coupled to the end cap 16 after manufacture, and in other embodiments, the outlet 94 can be substantially integral with the end cap 16. For example, in some embodiments, the inlet 92 can be in fluid communication with the first manifold 86a and the outlet 94 can be in fluid communication with the second manifold 86b. In some embodiments, the module 10 can comprise more than one inlet 92 and more than one outlet 94 in fluid communication with multiple manifolds 86 of the first and/or second end caps 16, 18.

In some embodiments, a coolant can flow through at least a portion of the module 10 to enhance cooling. In some embodiments, the coolant can comprise transmission fluid, ethylene glycol, an ethylene glycol/water mixture, water, oil, motor oil, a mist, a gas, or another substance capable of receiving heat energy produced by the electric machine module 10. In some embodiments, the inlet 92 can fluidly connect to a coolant source (not shown) that can at least partially pressurize the coolant prior to or as it flows through the inlet 92. Moreover, in some embodiments, at least a portion of the coolant can flow through the inlet 92 and enter the manifold 86a. In some embodiments, at least partially due to the pressure provided by the coolant source, the coolant can at least partially accumulate within the first manifold 86a and can flow through at least a portion of the coolant members 64 in fluid communication with the manifold 86a.

By way of example only, in some embodiments, the stator assembly 26 can comprise about thirty-two coolant members 64, and about half of the coolant members 64 can be in fluid communication with the first manifold 86a. Accordingly, in some embodiments, the coolant members 64 in fluid communication with the first manifold 86a can function as a coolant path for at least a portion of the coolant to circulate, as reflected by the arrows in FIG. 11. In some embodiments, the stator assembly 26 can comprise more than or fewer than thirty-two coolant members 64 and a different proportion of the total number of coolant members 64 (e.g., more or less than half of the total number) can be in fluid communication with the first manifold 86a. Moreover, in some embodiments, as previously mentioned, the o-rings 70, the retaining regions 68, and the angled regions 66 can at least partially function to seal the stator channels 30 so that no material amounts of fluid (e.g., coolant) can flow through the stator channels 30 from the manifolds 86a, 86b, 87. Accordingly, in some embodiments, at least a portion of the coolant flowing in a substantially axial direction flows through at least some of the coolant members 64.

In some embodiments, at least a portion of the coolant can axially flow through the stator assembly 26 from the first manifold 86a to a third manifold 87 (e.g., the manifold 87 of the second end cap 18), as reflected by the arrows in FIG. 11. In some embodiments, the coolant can flow from the first manifold 86a (e.g., from the first axial end 20 of the machine 14 toward the second axial end 22 of the machine 14 or vice versa). Moreover, in some embodiments, as previously mentioned, the manifold 87 of the second end cap 18 can comprise a substantially undivided structure so that all or nearly all of the coolant members 64 are in fluid communication with the manifold 87. As a result, at least a portion of the coolant that flows from the first manifold 86a can circulate through the coolant members 64 and enter the third manifold 87 of the second end cap 18. In some embodiments, because all or nearly all of the coolant members 64 are in fluid communication with the third manifold 87, at least a portion of the coolant can enter the third manifold 87 and circulate through the third manifold 87 in a substantially circumferential direction (e.g., substantially flood the third manifold 87 so that the third manifold 87 at least temporarily retains a volume of coolant).

Moreover, in some embodiments, because all or nearly all of the coolant members 64 are in fluid communication with the third manifold 87, at least a portion of the coolant can circulate through the third manifold 87 and can enter at least some of the coolant members 64 and flow toward the first end cap 16. In some embodiments, at least a portion of the coolant can flow through the coolant members 64 that are in fluid communication with the second manifold 86b. For example, because at least a portion of the coolant is directed through the coolant members 64 that are in fluid communication with the first manifold 86a, coolant can flow into and through the manifold 87 and enter at least a portion of the remaining coolant members 64, which can direct the coolant toward the second manifold 86b (e.g., in a substantially opposite axial direction) that is in fluid communication with the outlet 94. In some embodiments, the outlet 94 can fluidly connect the second manifold 86b and a heat-exchange element. As a result, in some embodiments, at least a portion of the coolant can circulate from the outlet 94 to the heat-exchange element (e.g., a radiator, a heat exchanger, etc.) so that at least a portion of the heat energy received by the coolant from the module 10 can be removed and the coolant can be re-circulated through the module 10 for further cooling.

As a result, in some embodiments, the module 10 can comprise a coolant path, as reflected by the arrows of FIG. 11. By way of example only, in some embodiments, coolant can enter the module 10 via the inlet 92 and can flow into the first manifold 86a. In some embodiments, at least a portion of the coolant can enter at least a portion of the coolant members 64 and flow in a generally axial direction toward the third manifold 87. In some embodiments, after entering the third manifold 87, at least a portion of the coolant can flow through some of the coolant members 64 in a generally axial direction toward the second manifold 86b. As a result of being fluidly connected to the outlet 94, at least a portion of the coolant that enters the second manifold 86b can exit the module 10 and coolant path via the outlet 94.

In some embodiments, as the coolant flows through at least a portion of the coolant members 64, it can receive at least a portion of the thermal energy produced by the electric machine 14 during operation. As previously mentioned, in some embodiments, the coolant members 64 can be disposed so that they are in thermal communication with the stator assembly 26. As a result, at least a portion of the heat energy produced by the elements of the module 10 (e.g., stator end turns 62, stator assembly 26, rotor assembly 24, etc.) can be convected and/or conducted to the stator assembly 26 where at least a portion of the heat energy can be transferred to the coolant flowing through the coolant members 64.

Moreover, some embodiments can provide enhanced cooling. For example, some conventional machines can comprise coolant jackets that may house coolant that passes through the machines once (e.g., substantially unidirectional from inlet to outlet). Accordingly, at least a portion of the coolant can exit some of these conventional electric machines with some heat energy, but the coolant may not have received an maximum amount of heat energy. Some embodiments of the invention provide improved cooling. For example, in some embodiments, as coolant flows in the first axial direction (e.g., from the inlet 92 and first manifold 86a toward the second end cap 18 and the third manifold 87), at least a portion of the coolant can receive a portion of the heat energy generated by the module 10. In some embodiments, as coolant circulates through the third manifold 87 and flows toward the outlet 94 via at least a portion of the coolant members 64, at least a portion of the coolant can receive further amounts of heat energy generated by the electric machine module 10, which can lead to improved cooling because greater amounts of heat energy can be received by the coolant and removed from the module 10 when the coolant exits the outlet 94.

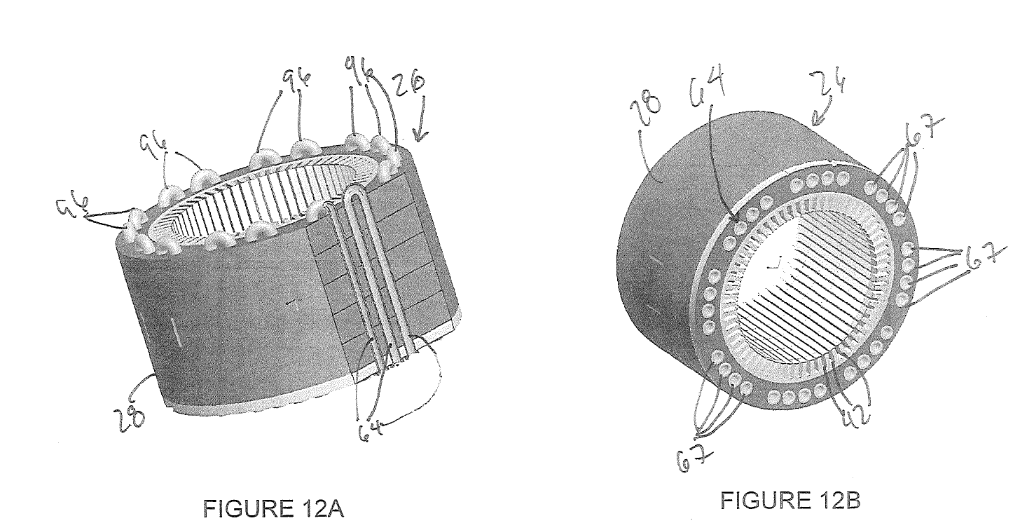

In some embodiments, the module 10 can comprise other cooling configurations. As shown in FIGS. 12A and 12B, in some embodiments, the stator assembly 26 and/or the housing 12 can comprise other configurations. As shown in FIG. 12A, in some embodiments, the stator assembly 26 can comprise coolant members 64 that are at least partially fluidly connected. For example, in some embodiments, the first end 65 of at least a portion of the coolant members 64 can comprise a curved region 96. In some embodiments, at least two coolant members 64 can be substantially fluidly coupled via the curved region 96. For example, in some embodiments, the curved region 96 can comprise a substantially “u-shaped” or “v-shaped” configuration, as shown in FIG. 12A. In some embodiments, the curved region 96 can comprise other configurations (e.g., square, rectangular, regular or irregular polygonal, etc.).

In some embodiments, the curved region 96 can be positioned in multiple manners. In some embodiments, the coolant members 64 can comprise a substantially linear configuration prior to formation of the curved region 96. For example, the substantially linear coolant member 64 can receive a force (e.g., bend, push, pull, other otherwise actuate) so that the coolant member 64 comprises a substantially similar configuration as to the coolant members 64 in FIG. 12A (e.g., the coolant member 64 is substantially bent to form the curved region 96). As a result, in some embodiments, a coolant member 64 can comprise two second ends 67 opposing the curved region 96. In some embodiments, the coolant member 64 can comprise two first ends 65 and a curved region 96.

In some embodiments, the curved region 96 can be positioned in other manners. For example, in some embodiments, the coolant members 64 can be at least partially disposed in the stator core 28, similar to some previously mentioned embodiments. After positioning the coolant members 64, in some embodiments, a curved region 96 can be coupled to neighboring coolant members 64 (e.g., substantially circumferentially adjacent coolant members 64). For example, in some embodiments, a separate curved region 96 (e.g., a pre-formed curved region 96 comprising a substantially similar material as the coolant members 64) can be coupled (e.g., welded, brazed, etc.) to the first and/or second ends 65, 67 of the coolant members 64.

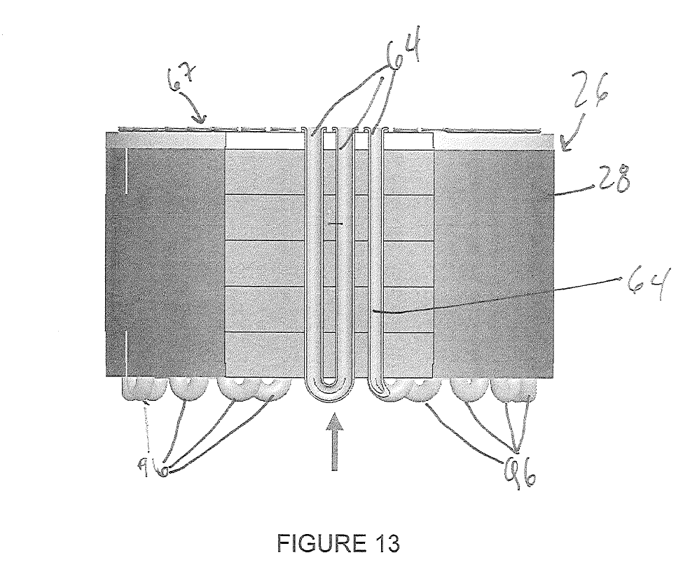

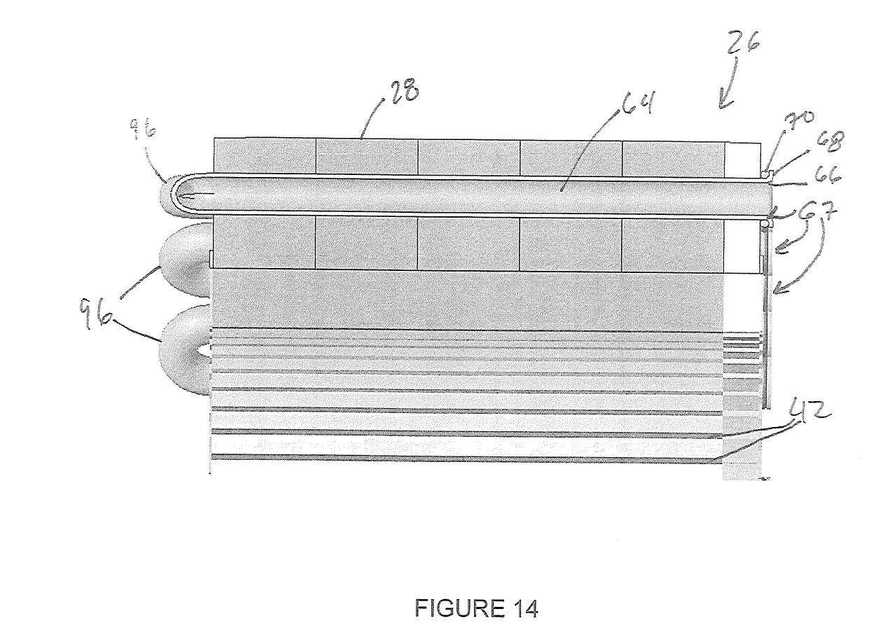

In some embodiments, the coolant members 64 can be disposed within the stator core 28 so that at least a portion of the curved regions 96 are on the same axial end of the stator core 28. In some embodiments, the first ends 65 of the coolant members 64 can comprise the curved regions 96, as previously mentioned and shown in FIG. 12A. By way of example only, in some embodiments, the coolant members 64 can be positioned within the stator channels 30 so that they comprise a curved region 96 between at least a portion the members 64 (e.g., at least some of the members 64 are bent to form a u-shaped coolant member 64). In some embodiments, the coolant members 64 can then be inserted into the stator channels 30 so that at least a portion of the curved regions 96 are on an axial end of stator assembly 26 (e.g., the first axial end 20 or the second axial end 22) and the second ends 67 of the coolant members 64 are on the opposite axial end of the stator assembly 26, as reflected by the arrow in FIG. 13. Furthermore, in some embodiments, after disposing at least a portion of the coolant members 64 within the stator channels 30, at least a portion of the second ends 67 can be configured and arranged substantially similar to some of the previously mentioned embodiments, including formation of the angled and retaining regions 66, 68 and positioning of the o-rings 70, as shown in FIG. 14. As a result, in some embodiments, the curved regions 96 can fluidly connect neighboring coolant members 64 at an axial end (e.g., the first axial end 20 or the second axial end 22) so that any coolant entering one of the second ends 67 can flow through the coolant members 64 in one axial direction, pass within the curved regions 96 and flow back toward the second ends 67 in an opposing axial direction.

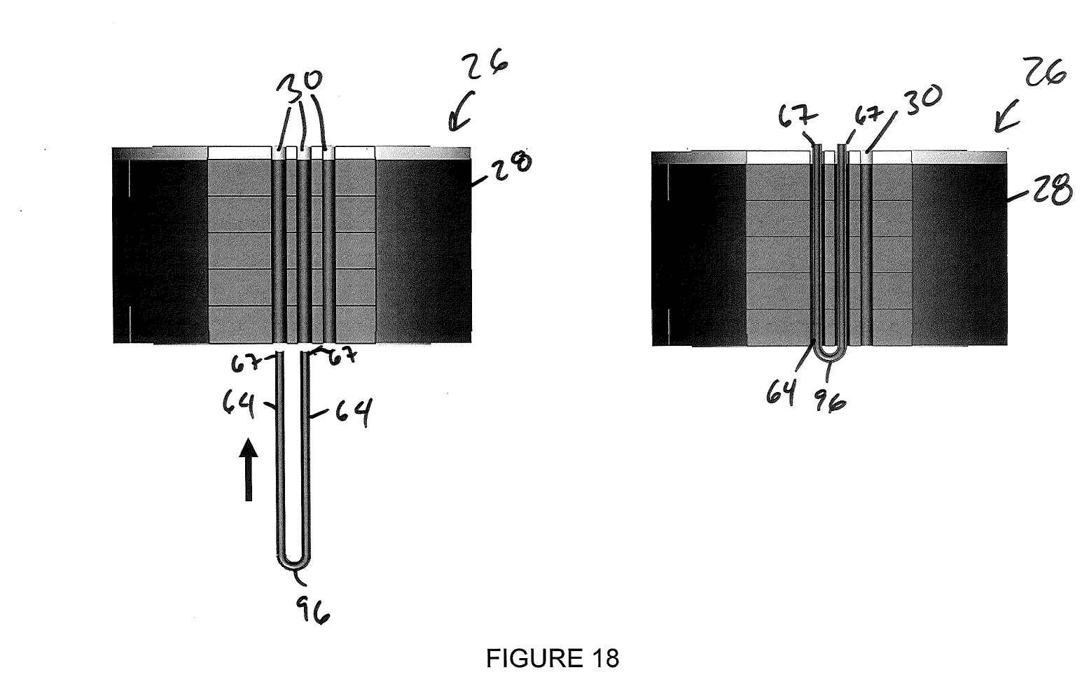

In some embodiments, the coolant members 64 can comprise alternative configurations and installation methods. In some embodiments, the coolant members 64 can comprise a material that can change configurations during assembly of the electric machine module 10. For example, in some embodiments, some or all of the coolant members 64 can comprise a polymer that has been extruded to form coolant members 64 comprising a curved region 96, as shown in FIG. 18. Moreover, in some embodiments, at least a portion of the coolant members 64 can be formed by extrusion. However, as previously mentioned, in some embodiments, the coolant members 64 can be formed in other manners.

In some embodiments, the extruded coolant members 64 can change configurations during assembly of the stator assembly 26. For example, after initial manufacture (e.g., via extrusion), the coolant members 64 can comprise a first outer diameter. As shown in FIG. 18, in some embodiments, the first outer diameter can comprise a smaller size relative to a second diameter of at least some of the stator channels 30. As a result, the coolant members 64 can be more easily positioned within the stator channels 30 (e.g., relative to coolant members 64 comprising a first diameter that is substantially similar to the second diameter) so that the curved regions 96 can extend from one axial end of the stator core 28 and the second ends 67 of the coolant members 64 can extend from the other axial end of the stator core 28, as shown in FIG. 18. In some embodiments, by forming at least some of the coolant members 64 by extrusion, production times and costs can be at least partially reduced. Moreover, the extruded coolant members 64 can more easily engage an inner surface of the stator channels 30 (e.g., relative to a copper-containing coolant member 64). For example, the coolant members 64 comprising a polymer or other extruded material can be readily deformable and can expanded into one or more voids defined by the textured surface of the stator channels 30.

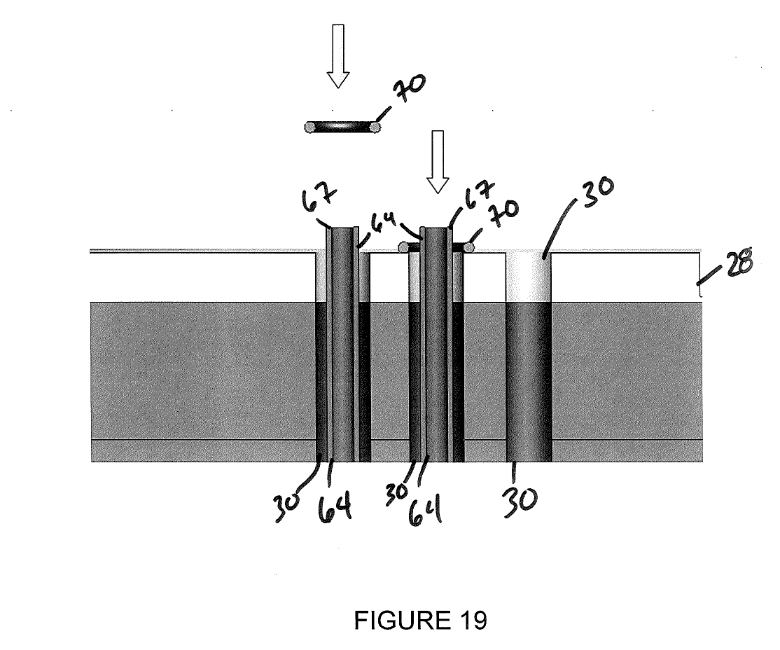

In some embodiments, the coolant members 64 can change configurations after being positioned within the stator channels 30. As previously mentioned, the coolant members 64 can comprise a less outer diameter than the diameter of the stator channels 30. As a result, coolant members 64 can move within the stator channels 30. In some embodiments, after positioning the coolant members 64 within the stator channels 30, one or more fluids can be circulated through the coolant members 64 to cause expansion (i.e., the fluids cause the coolant members 64 to expand so that the outer diameter of the coolant members 64 is substantially similar or the same as the diameter of the stator channels 30), as described in further detail below. Moreover, prior to or during changing configurations of the coolant members 64, in some embodiments, one or more o-rings 70 can be disposed adjacent to the second ends 67, as shown in FIG. 19. As a result, during reconfiguration of the coolant members 64, the o-rings 70 can be in position for sealing of the stator channels 30, as previously mentioned.

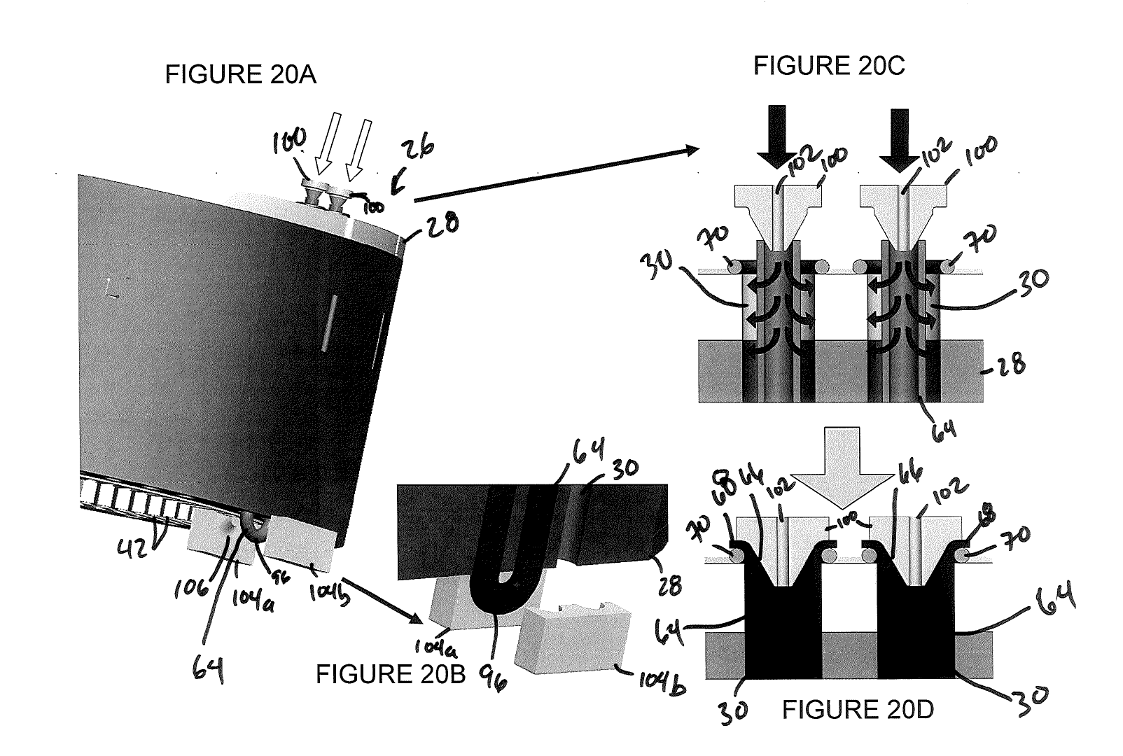

As shown in FIGS. 20A-20D, in some embodiments, the coolant members 64 can be expanded using a pressurized fluid. As shown in FIGS. 20A, 20C, and 20D, in some embodiments, one or more nozzles 100 can be disposed at least partially within or immediately adjacent to the second ends 67. In some embodiments, a nozzle 100 can be disposed in each of the second ends 67 of the coolant member 64. The nozzles 100 can be in fluid communication with a fluid source. For example, in some embodiments, the nozzles 100 can be fluidly connected to a high-pressure fluid source (e.g., a pressurized air source). In some embodiments, the nozzles 100 can comprise a fluid channel 102 that can enable the high pressure fluid to enter the coolant members 64. As shown in FIG. 20C, in some embodiments the high pressure fluid can enter the nozzles 100, and, at least a portion of the high pressure fluid can enter the coolant members 64 via the fluid channels 102. For example, in some embodiments, when the nozzle 100 is at least partially positioned within the coolant members 64, the nozzles 100 can substantially or completely seal the coolant members 64 so that pressurized fluid (as represented by arrows in FIG. 20C) can cause the coolant members 64 to expand, as shown in FIGS. 20C and 20D. In some embodiments, the high pressure fluid can cause the expansion of the coolant members 64 at least partially because of the polymer composition that at least a portion of the coolant members 64 can comprise. For example, the polymer (e.g., polyethylene terephthalate) can readily expand in response to the presence of the radially outward directed pressure arising form the introduction of the high pressure fluid.

As shown in FIGS. 20A and 20B, a retaining member 104 can be coupled to a portion of at least some of the coolant members 64 to retain them during the introduction of the high pressure fluid. In some embodiments, the retaining member 104 can be configured and arranged to receive at least a portion of the coolant members 64. For example, as shown in FIGS. 20A and 20B, the retaining member 104 can be configured to receive the curved region 96 of the coolant members 64. In some embodiments, the retaining member 104 can comprise a first retaining member 104a and a second retaining member 104b that that can be configured to receive a first portion of the coolant member 64 (e.g., a radially outer portion of the coolant member 64) and a second portion of the coolant member 64 (e.g., a radially inner portion of the coolant member 64), respectively. For example, in some embodiments, the first and second retaining members 104a, 104b can comprise receiving regions 106 that are configured receive portions of the curved region 96. As shown in FIGS. 20A and 20B, the first and second receiving members 104a, 104b can be positioned so that the curved region 96 is at least partially retained and/or supported so that when high pressure fluid is introduced into the coolant members 64, the members 64 are not able to significantly move (e.g., in a generally axial direction).

Moreover, in some embodiments, in addition to providing a conduit for the high pressure fluid to reach the coolant members 64, the nozzles 100 can also be configured to form the angled and retaining regions 66, 68, as shown in FIGS. 20C and 20D. In some embodiments, the nozzles 100 and the forming tool 72 can comprise substantially similar configurations. For example, before, during, or after the expansion of the coolant members 64 via the high pressure fluid, the nozzles 100 can be moved in a generally axially inward direction to apply a force to the second end 67. As shown in FIGS. 20C and 20D, the movement of the nozzles 100 can cause the second end 67 to change shape from substantially linear (as shown in FIG. 20C) to a shape comprising the angled and retaining regions 66, 68 (as shown in FIG. 20D). Moreover, the o-rings 70 can be secured in location to seal the stator channels 30 because they were positioned prior to expansion of the coolant members 64, as previously mentioned.

Additionally, in some embodiments, the retaining member 104 can function to prevent axial movement of the coolant member 64 when the nozzles 100 move axially inward to ensure formation of the angled and retaining regions 68. In some embodiments, a single retaining member 104 and two nozzles 100 can be used in the assembly process (e.g., one coolant member 64 can be configured at a time), however, in other embodiments, greater numbers of retaining members 104 and nozzles 100 can be used (e.g., multiple coolant members 64 can be configured in a substantially synchronous manner). Moreover, in some embodiments, a single retaining member 104 can be configured to receive some or all of the curved regions 96 and a body (not shown) can comprise a plurality of nozzles 100 so that some or all of the coolant members 64 can be configured at the same or similar times.

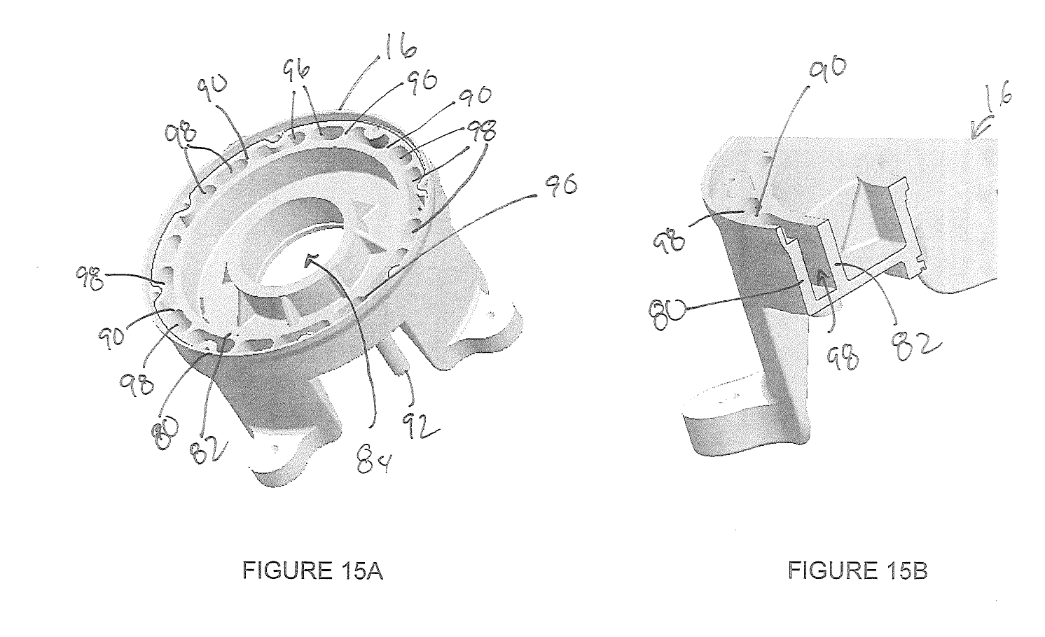

Moreover, in some embodiments, at least one of the end caps 16, 18 can comprise alternative configurations. Although the following discussion largely refers to the first end cap 16, the second end cap 18 can comprise a similar configuration or both end caps 16, 18 can comprise a similar alternative configuration. In some embodiments, the first end cap 16 can comprise a plurality of recesses 98. As shown in FIGS. 15A and 15B, in some embodiments, the first end cap 16 can comprise a plurality of substantially axially-oriented recesses 98 disposed between the outer flange 80 and the inner flange 82. In some embodiments, at least a portion of the recesses 98 can be substantially circumferentially oriented with respect to the end cap 16. For example, as shown in FIG. 15A, in some embodiments, a plurality of ribs 90 can be disposed (e.g., substantially circumferentially disposed and substantially radially oriented) between the inner flange 82 and the outer flange 80 to at least partially define the recesses 98. Furthermore, and by way of example only, in some embodiments, the first end cap 16 can be formed (e.g., casted, molded, extruded, etc.) so that the ribs 90 and the recesses 98 are created during end cap manufacture. In other embodiments, the ribs 90 can be coupled to the flanges 80, 82 and other portions of the end cap 18 at other times to define at least a portion of the recesses 98. Additionally, in some embodiments, the recesses 98 can be configured and arranged to receive at least a portion of the coolant members 64 (e.g., at least a portion of the second ends 67 can be at least partially disposed within a portion of the recesses 98). Moreover, in some embodiments, the inlet 92 and the outlet 94 can be disposed through a portion of the end cap 16 so that the inlet 92 is in fluid communication with at least one of the recesses 98 and the outlet 94 is in fluid communication with one of the recesses 98 (e.g., the same or a different recess 98).

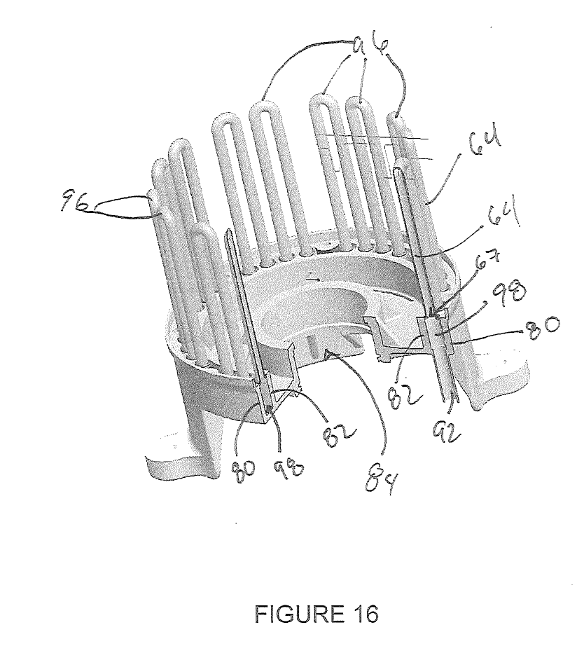

In some embodiments, the stator assembly 26 can be coupled to the end caps 16, 18 so that at least a portion of the second ends 67 are in fluid communication with at least a portion of the recess 98. For example, as represented in FIG. 16, in some embodiments, the end caps 16, 18 can be coupled to the stator assembly 26 so that the second ends 67 are at least partially received within the recesses 98 so that at least a portion of a fluid (e.g., coolant) received within the recesses 98 can enter and circulate through the coolant members 64. Furthermore, in some embodiments, a structure (e.g., an o-ring or other structure) (not shown) can be disposed between an axial side of the stator assembly 26 comprising the second ends 67 and the end cap 16 to seal at least a portion of the recesses 98. For example, in some embodiments, during assembly, the structure can be positioned so that no substantial amounts of fluid entering the recesses 98 (e.g., via the inlet 92 or the coolant members 64) can exit the recesses 98 other than flowing through the coolant members 64 or the outlet 94.

Moreover, in some embodiments, the second end cap 18 can be configured and arranged to receive at least a portion of the curved regions 96. For example, in some embodiments, the outer flange 80 and the inner flange 82 can be spaced apart by a radial distance substantially similar to a width of the curved regions 96 so that the curved regions 96 can be at least partially received between the flanges 80, 82 of the second end cap 18 when the stator assembly 26 is coupled to the end caps 16, 18. Furthermore, in some embodiments, the curved regions 96 can be received within the second end cap 18 such that at least a portion of the curved regions 96 are in thermal communication with the second end cap 18. For example, as detailed in greater detail below, thermal energy can be conducted to the end cap 18 via the coolant members 64 or vice versa.

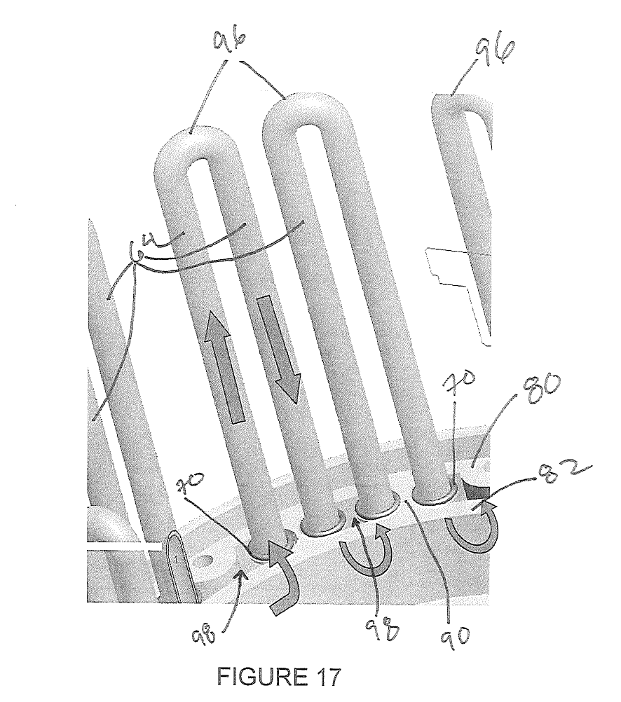

In some embodiments, at least a portion of the coolant can flow through coolant members 64 in a substantially continuous circuit. As previously mentioned, and represented in FIGS. 16 and 17, in some embodiments, at least a portion of the coolant members 64 can extend into at least a portion of the recesses 98. Moreover, in some embodiments, the recesses 98 can be substantially sealed (e.g., via a sealing structure, as previously mentioned) so that coolant entering the recesses 98 can generally flow through the coolant members 64. Furthermore, in some embodiments, the second ends 67 of any single coolant member 64 can be disposed in different recesses 98 to at least partially provide a substantially continuous coolant circuit.

For example, in some embodiments, the inlet 94 can be fluidly connected to at least one of the recesses 98 (e.g., a first recess 98) and at least one of the coolant members 64 can be in fluid communication with the first recess 98. Moreover, the coolant member 64 that is in fluid communication with the inlet 94 can include a first second end 67 that is in fluid communication with the first recess 98 and another second end 67 that is in fluid communication with a second recess 98, as shown in FIG. 17. In some embodiments, at least one other coolant member 64 can include a first second end 67 that is in fluid communication with the second recess 98 and another second end 67 that is in fluid communication with a third recess 98. In some embodiments, at least a portion of the previously mentioned pattern can continue around some or all of a circumference of the stator assembly 26 so that coolant can flow through the coolant members 64 in an at least partially continuous coolant circuit. As a result and by way of example only, as reflected by the arrows in FIG. 17, coolant can enter the first recess 98 and enter a first second end 67 of at least one of the coolant members 64. In some embodiments, at least a portion of the coolant can flow from the first recess 98 through the second end 67 toward the curved region 96 and then return the other second end 67 that is in fluid communication with the second recess 98. In some embodiments, coolant can then flow through a second end 67 of a separate coolant member 64 in fluid communication with the second recess 98 and circulate through that coolant member 64 and then be dispersed in the third recess 98. Furthermore, in some embodiments, the previously mentioned pattern can substantially continuously repeat (e.g., in a generally circumferential direction) through the plurality of coolant members 64 and recesses 98 until the coolant circulates into the recess 98 that is fluidly coupled to the outlet 94. After reaching the outlet 94, similar to some previously mentioned embodiments, the coolant can flow through a heat-exchange element and can be recycled for further cooling.

As a result, coolant can be substantially continuously flowing in both axial directions (e.g., both axial directions through the coolant members 64) and a circumferential direction (e.g., coolant entering and exiting the plurality of recesses 98 when exiting and entering second ends 67 of the coolant members 64). Moreover, in some embodiments, as coolant flows in many of the previously mentioned directions, it can receive at least a portion of the thermal energy produced by the electric machine 14 during operations, which can lead to cooling of the module 10.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of assembling an electric machine module, the method comprising:
assembling a stator core from a plurality of laminations, the stator core comprising a plurality of slots, a first axial end, and a second axial end;
positioning a plurality of stator channels through at least a portion of the stator core so that at least some of the plurality of stator channels extend from the first axial end to the second axial end;
forming a plurality of coolant members comprising a curved region;
positioning the plurality of coolant members within the plurality of stator channels; and
introducing a pressurized fluid into at least some of the coolant members to expand the coolant members into engagement with at least a portion of the stator channels.

2. The method of claim 1, wherein forming the plurality of coolant members comprises extruding the plurality of coolant members.

3. The method of claim 1, wherein the coolant members comprise a polymer.

4. The method of claim 1 and further comprising coupling a nozzle to at least a portion of the coolant members to introduce the pressurized fluid.

5. The method of claim 1 and further comprising coupling at least one retaining member to the curved region.

6. The method of claim 5, wherein the retaining member is configured and arranged to retain the coolant members in position during introduction of the pressurized fluid.

7. The method of claim 1, wherein the pressurized fluid comprises high pressure air.

8. The method of claim 1, wherein at least a portion of the plurality of stator channels are positioned radially outward relative to the plurality of slots.

9. The method of claim 8 and further comprising positioning a stator winding at least partially within the plurality of slots.

10. The method of claim 1 and further comprising coupling a first end cap and a second end cap to the first axial end and the second axial end of the stator core, respectively.

11. An electric machine module comprising:
a housing including a first end cap and a second end cap, at least one of the first end cap and the second end cap comprising a plurality of recesses including at least a first recess, a second recess, and a third recess; and
an electric machine operatively coupled to the first end cap and the second end cap, the electric machine including a stator assembly including stator end turns, the stator assembly further comprising
a first axial end and a second axial end,
at least one first coolant member disposed through at least a portion of the stator assembly and extending from at least the first axial end to the second axial end, and the at least one first coolant member including a curved region and being in fluid communication with the first recess and the second recess, and
at least one second coolant member disposed through at least a portion of the stator assembly and extending from at least the first axial end to the second axial end, and the at least one second coolant member including a curved region and being in fluid communication with the second recess and the third recess, wherein the at least one first coolant member and the at least one second coolant member comprise a polymer and are configured and arranged to expand into engagement with the stator assembly.

12. The electric machine module of claim 11, wherein at least one of the first end cap and the second end cap comprises a plurality of ribs.

13. The electric machine module of claim 11, wherein at least one of the first end cap and the second end cap comprises at least one inlet.

14. The electric machine module of claim 13, wherein the at least one inlet is in fluid communication with at least one of the plurality of recesses.

15. The electric machine module of claim 11, wherein the stator assembly comprises a plurality of coolant members.

16. The electric machine module of claim 15, wherein each of the plurality of coolant members are in fluid communication with at least two of plurality of the recesses.

17. The electric machine module of claim 11, wherein at least one of the first end cap and the second end cap comprises at least one outlet that is in fluid communication with at least one of the plurality of recesses.

18. The electric machine module of claim 11, wherein the first and the second coolant members are capable of receiving a pressurized fluid to expand into engagement with the stator assembly.

19. A method of assembling an electric machine module, the method comprising:
providing a first end cap and a second end cap;
providing an electric machine including a stator core comprising a first axial end and a second axial end;
positioning a plurality of stator channels through at least a portion of the stator core so that at least some of the plurality of stator channels extend from the first axial end to the second axial end;
extruding a plurality of coolant members so that the plurality of coolant members each comprise a curved region, the plurality of coolant members comprising a polymer;
positioning the plurality of coolant members within the plurality of stator channels so that portions of the plurality of coolant members extend from the first axial end and the second axial end;
coupling a retaining member to a portion of at least one of the plurality of coolant members;
introducing a pressurized fluid from one or more nozzles into at least one of the plurality of coolant members to engage the coolant members with the stator channels; and
coupling the first end cap to the first axial end of the stator core and the second end cap to the second axial end of the stator core.

20. The method of claim 19 and further comprising forming at least one angled region and at least one retaining region by applying an axially inward force to the coolant members with the one or more nozzles.
